(19) United States
(12) Patent Application Publication
(10) Pub. No.: US 2024/0124370 A1
(43) Pub. Date: Apr. 18, 2024

(54) MACRONUTRIENT COMPOSITIONS WITH SUPRAMOLECULAR STRUCTURES FOR AGRICULTURAL USE

(71) Applicant: BPS JUST ENERGY TECHNOLOGY, LLC, Argyle, TX (US)

(72) Inventors: Blake YOUNG, Argyle, TX (US); David COORTS, Argyle, TX (US); Donna SHOTWELL, Argyle, TX (US); Robert GEIGER, Argyle, TX (US)

(21) Appl. No.: 18/247,613

(22) PCT Filed: Oct. 21, 2020
(86) PCT No.: PCT/US2020/056705

§ 371 Date: Mar. 31, 2023

Related U.S. Application Data
(60) Provisional application No. 63/086,355, filed on Oct. 1, 2020.

(51) Int. Cl. C05G 3/40; C05D 9/02

(52) U.S. Cl. CPC C05G 3/40; C05D 9/02

(57) ABSTRACT

Compositions with supramolecular structures for use in agricultural methods include a source of macronutrients such as a fertilizer, a supramolecular host chemical or a supramolecular guest chemical configured to engage in host-guest chemistry with the source of macronutrients, and a solvent. Formulations for combination with a macronutrient source are also included. Methods of treating a plant to improve nutrient assimilation or vigor include applying an agriculturally effective amount of the composition to the plant.

### FIELD

The present disclosure relates to agricultural compositions that provide macronutrients to plants, and methods of treating a plant to improve nutrient assimilation or vigor.

### BACKGROUND OF THE DISCLOSURE

Carbon, hydrogen, oxygen, nitrogen, phosphorus, and sulfur are the primary elements essential to all life. Soils contain these elements, as well as other macronutrients and micronutrients that are helpful to or even needed for plant growth, but due to various reasons, nutrients can become unavailable and have minimal uptake causing reduction in nutrient assimilation. To overcome these challenges, various growing techniques have been employed, such as slow release fertilizers, acidifiers, different bio-stimulants, various growth promoting agents, plant growth adjustment agents, or physiological activity promoting agents.

Even though these techniques overcome different and difficult situations, there has been a growing concern on increasing nutrient use efficiency to minimize the potential to environmental pollution by over application.

The fertilizer industry has relatively little to no new synthetic chemistry in the last 40 years. Nutrients tend to be over-applied in the crop industry, with around 60-65% of nitrate fertilizer utilized by the plants in one season, 12-15% retained in soil organic matter up to a quarter century after application, and 8-12% leaked toward the hydrosphere. Excess nitrogen and phosphorus applied can be washed to the groundwater over time and cause eutrophication in water bodies, which eutrophication can lead to hypoxia resulting in a decrease of aquatic life.

Accordingly, improved compositions and methods are needed to increase nutrient assimilation while minimizing or avoiding negative environmental impact

### SUMMARY OF THE DISCLOSURE

In a first aspect, the disclosure encompasses an agricultural composition that includes: a macronutrient source; a supramolecular host chemical or a supramolecular guest chemical configured to engage in host-guest chemistry with the macronutrient source; and a solvent. In one embodiment, the macronutrient source comprises nitrogen, phosphorus, potassium, calcium, magnesium, or optionally sulfur, or a salt thereof, or a combination thereof.

In one preferred embodiment, the composition further includes agricultural additives that include one or more of: a biostimulant; a sugar; an acid; an iron source; and a surfactant. In each of the embodiments described above, the macronutrient source may be present in an amount of about 0.01 to 35 percent by weight of the composition.

In another aspect, the disclosure encompasses a method of preparing any of compositions described herein by: forming a mixture of the solvent and the supramolecular host chemical or the supramolecular guest chemical; and adding the macronutrient source to form the composition.

In yet a third aspect, the disclosure encompasses a method of treating a plant to increase or otherwise improve nutrient assimilation or vigor, including by: applying an agricultural composition to the plant in an agriculturally effective amount, the composition including a macronutrient source; a supramolecular host chemical or a supramolecular guest chemical configured to engage in host-guest chemistry with the macronutrient source; and a solvent. In a preferred embodiment, the macronutrient source can be a fertilizer and includes nitrogen, phosphorus, potassium, calcium, magnesium, or optionally sulfur, or a salt thereof, or a combination thereof. In one embodiment, the method increases a plant weight or a nutrient uptake in the plant compared to a plant that did not receive the agriculturally effective amount of the composition. In yet another embodiment, there is an increased nutrient uptake of nitrogen, phosphorous, potassium, calcium, magnesium, optionally sulfur, or a combination thereof in the plant.

In another aspect, the disclosure encompasses a method of increasing the assimilation of one or more macronutrients in a plant, which includes applying an agriculturally effective amount of any of the agricultural compositions to the plant. In a preferred embodiment, the agricultural composition further includes an additive of one or more of: adjuvants, water conditioning agents, buffering agents, defoamers, drift control agents, stickers, spreaders, tank cleaners, fertilizers, or biostimulants.

In a further aspect, the disclosure encompasses an agricultural formulation including: a macronutrient source including a fertilizer which comprises nitrogen, phosphorus, potassium, calcium, magnesium, optionally sulfur, or a salt thereof, or a combination thereof; a plurality of agricultural additives that includes: a biostimulant, a sugar, an acid, an iron source, and a surfactant; a supramolecular host chemical or a supramolecular guest chemical configured to engage in host-guest chemistry with at least one of the agricultural additives; and a solvent. In preferred embodiments, the sugar includes glucose or fructose; the biostimulant comprises humic acid; the acid comprises citric acid; the iron source comprises an iron chelate; and the surfactant comprises an ethoxylate.

In another aspect, the disclosure encompasses a method of increasing the assimilation of one or more macronutrients in a plant, which includes: combining an agriculturally effective amount of the agricultural formulation, and a macronutrient source to form an agricultural composition; and applying the agricultural combination to the plant to increase assimilation to the plant of at least one macronutrient in the macronutrient source.

### BRIEF DESCRIPTION OF THE DRAWINGS

The present disclosure is best understood from the following detailed description when read with the accompanying figures.

FIGS. 1A-1D show the crystal structures of a 20-20-20 fertilizer/water solution;

FIGS. 2A-2C show the encapsulation of supramolecular structures in a 20-20-20 fertilizer/water solution with the composition of Example 1, according to aspects of the present disclosure;

FIGS. 3A-3B show randomized crystals in a 20-20-20 fertilizer/water solution with the control composition of Example 1;

FIG. 4 is a graph showing the increased dry biomass in sweet basil of Example 3, according to aspects of the present disclosure;

FIG. 5 is a graph showing the increased dry biomass in vincas of Example 3, according to aspects of the present disclosure;

FIG. 6 is a graph showing the increase in macronutrient assimilation in sweet basil of Example 3 treated with the composition of Example 1 compared to a control, according to aspects of the present disclosure;

FIG. 7 a graph showing the increase in macronutrient assimilation in vincas of Example 3 treated with the composition of Example 1 compared to a control, according to aspects of the present disclosure;

FIG. 8 is a graph showing the total dry biomass in corn of Example 4 treated with different concentrations of nitrogen and different concentrations of the composition of Example 1, according to aspects of the present disclosure;

FIG. 9 is a graph showing the macronutrient percent change in corn of Example 4 compared to the control treated with different concentrations of nitrogen and different concentrations of the composition of Example 1, according to aspects of the present disclosure;

FIG. 10 is a graph showing total nitrogen uptake in corn of Example 4 treated with different concentrations of nitrogen and different concentrations of the composition of Example 1, according to aspects of the present disclosure;

FIG. 11 is a graph showing total phosphorous uptake in corn of Example 4 treated with different concentrations of nitrogen and different concentrations of the composition of Example 1, according to aspects of the present disclosure;

FIG. 12 is a graph showing total potassium uptake in corn of Example 4 treated with different concentrations of nitrogen and different concentrations of the composition of Example 1, according to aspects of the present disclosure;

FIG. 13 is a graph showing total calcium uptake in corn of Example 4 treated with different concentrations of nitrogen and different concentrations of the composition of Example 1, according to aspects of the present disclosure;

FIG. 14 is a graph showing total magnesium uptake in corn of Example 4 treated with different concentrations of nitrogen and different concentrations of the composition of Example 1, according to aspects of the present disclosure; and

FIG. 15 is a graph showing total sulfur uptake in corn of Example 4 treated with different concentrations of nitrogen and different concentrations of the composition of Example 1, according to aspects of the present disclosure;

### DETAILED DESCRIPTION OF THE PREFERRED EMBODIMENTS

This disclosure provides compositions and methods for treating plants to accelerate vegetation and growth. The compositions include macronutrient source(s) with supramolecular structures that enhance assimilation of the soil macronutrients in plant systems.

Two classes of nutrients are considered essential for plants: macronutrients and micronutrients. Macronutrients are the building blocks of crucial cellular components like proteins and nucleic acids. Nitrogen, phosphorus, magnesium, and potassium are some of the most important macronutrients. Carbon, hydrogen, and oxygen are also considered macronutrients, as they are required in relatively larger quantities to build the larger organic molecules of the cell. Micronutrients, including iron, zinc, manganese, and copper, are required in relatively very small amounts. Micronutrients are often required as cofactors for enzyme activity.

Macronutrients are divided into two groups: primary and secondary. The primary macronutrients are those that are typically desired or needed in the highest concentration: nitrogen (N), phosphorus (P) (e.g., P₂O₅), and potassium (K) (e.g., K₂O). In fact, these three primary nutrients are generally needed in higher concentrations than the rest of the macronutrients combined. Secondary macronutrients are also required for sustained plant health, but in lower quantities than the primary macronutrients. Calcium (Ca), magnesium (Mg), and sulfur (S) are generally the important secondary macronutrients. In one embodiment, the secondary macronutrients include calcium, magnesium, or a combination thereof.

The compositions include a supramolecular host structure or guest structure mixture in an aqueous solvent, such as water, that promotes supramolecular structures and increased macronutrient assimilation in plants. The formation of supramolecular structures increases such macronutrient assimilation in plants. In various embodiments, the compositions include primary and secondary macronutrient supramolecular structures that increase nutrient assimilation and overall plant growth and vigor.

The compositions can be applied by any suitable method, such as injection, drip, broadcast, banding, soil drench, foliarly, by fertigation, aerially, or other conventional methods, or any combination thereof. As further discussed below, the compositions increase nutrient assimilation, and overall plant growth and vigor. As used herein, “vigor” of a plant means plant weight (including tissue mass or root mass, or a combination thereof), plant height, plant canopy, visual appearance, or any combination of these factors. Thus, increased vigor refers to an increase in any of these factors by a measurable or visible amount when compared to the same plant that has not been treated with the compositions disclosed herein.

In certain embodiments, the compositions include (1) a macronutrient source; (2) a supramolecular host or guest chemical configured to engage in host-guest chemistry with the macronutrient source; (3) a solvent, preferably an aqueous solvent; (4) additives, commonly used additives in the agricultural industry. Such supramolecular structures or assemblies may take the form of, e.g., micelles, liposomes, nanostructures, or nanobubbles.

In several embodiments, the compositions of macronutrients with supramolecular structures enhance assimilation of the soil macronutrients in plant systems. The macronutrients may be primary (e.g., carbon, hydrogen, oxygen, nitrogen, phosphorus, potassium) and/or secondary (e.g., calcium, magnesium, and sulfur). In some embodiments, the compositions include a supramolecular host structure mixture in water that promotes supramolecular structures and increased macronutrient assimilation. Advantageously, the formulation of supramolecular structures increases macronutrient assimilation in plants.

In some embodiments, the macronutrient source includes one or more source of nitrogen, phosphorus, potassium, calcium, sulfur, or magnesium, or a salt thereof. For example, the macronutrient source may include potassium oxide or phosphorus pentoxide, or a combination. In several embodiments, the macronutrient source includes a fertilizer. As used herein, a “fertilizer” is any natural or synthetic substance that is applied to soil or plants to improve growth and productivity. Fertilizers provide nutrients to plants. The fertilizer that can be utilized can be any chemical moiety, natural or synthetic, that serves as a source of macronutrients and/or micronutrients for the plant under consideration.

The macronutrient source, or source of one or more macronutrients, is present in the composition in any suitable amount but is generally present in the composition in less than about 75 percent of the composition. Depending on various factors including macronutrients present in local soil, type of crop, etc., various amounts of macronutrient source may be present in the composition disclosed herein, such as from about 0.01 percent to about 50 percent by weight, from about 0.1 to about 30 percent by weight, from about 0.5 to 20 percent by weight, or from about 1 to 10 percent by weight of the composition. Depending on the application method used, the grower can dilute the macronutrient fertilizer source by air (e.g., by spraying) or water before application. The inventive blend is typically mixed in with the macronutrient source before dilution occurs to form the supramolecular structure. Macronutrients are typically applied by various methods to an agricultural growing system with common methods being injected, drip, fertigation, foliar, broadcast, banded, aerial, and other various forms of application common in agriculture systems.

In selecting suitable supramolecular host or guest chemical(s), (1) the host chemical generally has more than one binding site, (2) the geometric structure and electronic properties of the host chemical and the guest chemical typically complement each other when at least one host chemical and at least one guest chemical is present, and (3) the host chemical and the guest chemical generally have a high structural organization, i.e., a repeatable pattern often caused by host and guest compounds aligning and having repeating units or structures. In some embodiments, the supramolecular host chemical or supramolecular guest chemical is provided in a mixture with a solvent. A preferred solvent includes an aqueous solvent, such as water. Host chemicals may include nanostructures of various elements and compounds, which may have a charge, may have magnetic properties, or both. Suitable supramolecular host chemicals include cavitands, cryptands, rotaxanes, catenanes, or any combination thereof.

Cavitands are container-shaped molecules that can engage in host-guest chemistry with guest molecules of a complementary shape and size. Examples of cavitands include cyclodextrins, calixarenes, pillarrenes, and cucurbiturils. Calixarenes are cyclic oligomers, which may be obtained by condensation reactions between para-t-butyl phenol and formaldehyde.

Cryptands are molecular entities including a cyclic or polycyclic assembly of binding sites that contain three or more binding sites held together by covalent bonds, and that define a molecular cavity in such a way as to bind guest ions. An example of a cryptand is N[CH₂CH₂OCH₂CH₂OCH₂CH₂]3N or 1,10-diaza-4,7,13,16,21,24-hexaoxabicyclo[8.8.8]hexacosane. Cryptands form complexes with many cations, including NH4+, lanthanoids, alkali metals, and alkaline earth metals.

Rotaxanes are supramolecular structures in which a cyclic molecule is threaded onto an “axle” molecule and end-capped by bulky groups at the terminal of the “axle” molecule. Another way to describe rotaxanes are molecules in which a ring encloses another rod-like molecule having end-groups too large to pass through the ring opening. The rod-like molecule is held in position without covalent bonding.

Catenanes are species in which two ring molecules are interlocked with each other, i.e., each ring passes through the center of the other ring. The two cyclic compounds are not covalently linked to one another but cannot be separated unless covalent bond breakage occurs.

Suitable supramolecular guest chemicals include cyanuric acid, water, and melamine, and are preferably selected from cyanuric acid or melamine, or a combination thereof. Another category of guest chemical includes nanostructures of various elements and compounds, which may have a charge, may have magnetic properties, or both.

The supramolecular host chemical or the supramolecular guest chemical is present in the composition in any suitable amount but is generally present in the composition in an amount of about 1 percent to about 90 percent by weight of the composition. In certain embodiments, the supramolecular host chemical or supramolecular guest chemical, or host and guest chemical combination, is present in an amount of about 50 percent to about 85 percent by weight of the composition, for example, 60 percent to about 80 percent by weight of the composition.

Any solvent may be used, including for example water, alcohol, or air. Typically, an aqueous solvent is used, and water is used as a preferred aqueous solvent. The solvent is typically present in an amount that is at least sufficient to partially and preferably substantially dissolve any solid components in the composition. Water (or other polar solvent) is present in any suitable amount but is generally present in the composition in an amount of about 0.5 percent to about 80 percent by weight of the composition. In certain embodiments, water is present in an amount of about 5 percent to about 75 percent by weight of the composition, for example, 50 percent to about 70 percent by weight of the composition. In various embodiments, the solvent partially dissolves one more components of the composition. In some embodiments, the solvent is selected to at least substantially dissolve (e.g., dissolve at least 90%, preferably at least about 95%, and more preferably at least about 99% or 99.9%, of all the components) or completely dissolve all of the components of the composition.

Any common agriculture additives can be used in the composition depending on the intended applications. Examples are one or more adjuvants, water condition agents, buffering agents, defoamers, drift control agents, stickers, spreaders, tank cleaners, fertilizer, and bio stimulants.

The order of addition of the components of the composition can be important to obtain stable supramolecular structures or assemblies in the final mixture. The order of addition is typically: (1) a solvent, (2) any optional additive or additives, and (3) a supramolecular host chemical or a supramolecular guest chemical. Once these two or three components are fully mixed, the supramolecular structure can be formed by mixing with a macronutrient source of choice, serially or sequentially. For example, the macronutrient source may provide a primary macronutrient (one or more of nitrogen, phosphorus, or potassium) and/or a secondary macronutrient (one or more of calcium, magnesium, or sulfur).

The compositions described above are typically applied in an agriculturally effective amount to each plant (e.g., the soil, roots, stems, or leaves of the plant, or a combination thereof). The amount or concentration of the present compositions to be applied can vary depending on conditions (e.g., application technique, wind speed, soil, humidity, pH, temperature, growing season, amount of daily light, amount of nitrogen to be applied, etc.), the concentration and type of components as described herein, as well as the type of plant to which each composition is applied. In some embodiments, an “agriculturally effective amount” means from about 5 ppm to about 700 ppm of the composition per gram of media (e.g., soil or soilless media) the plant is placed in. In various embodiments, the rate of application is determined by the amount of currently available macronutrients (if any), and any amounts specifically required for the intended plant. In some embodiments, the composition is applied at a concentration of about 1 to 30 mL of the composition per gallon of the carrier fluid, for example about 1.0 to about 1.5 mL of the composition per gallon, about 2.0 mL to about 8.0 mL of the composition per gallon, or about 9.0 mL to about 20.0 mL of the composition per gallon. In various embodiments, the composition is applied at a rate of about 1 to 100 ounces of the composition per acre of the crop to be treated, for example, about 1 ounce to about 3 ounces of the composition per acre, about 4 ounces to about 65 ounces per acre, or about 70 ounces to about 90 ounces of the composition per acre.

The term “about,” as used herein, should generally be understood to refer to both numbers in a range of numerals even if it appears only before the first number in a range (unless not permitted, in which case the presence of the word about should be ignored). Moreover, all numerical ranges herein should be understood to include each whole integer and tenth of an integer within the range.

The following examples are illustrative of the compositions and methods discussed above and are not intended to be limiting.

### EXAMPLES

### Example 1: Preparation of Ready-to-Use Formulations

A ready-to-use (RTU) formulation was prepared using the components and quantities listed in Table 1 below. The order of addition of the components can be important to obtain stable supramolecular structures in the final mixture. The order was as follows: humic acid, SymMAX™ supramolecular host or guest mixture with water, glucose, citric acid, iron chelate, surfactant and SymMAX™ supramolecular host or guest mixture with water. These RTU formulations may be then be combined with macronutrients according to the disclosure herein to form the compositions disclosed herein.

TABLE 1
RTU FORMULATION COMPONENTS AND AMOUNTS

| | Example | | |
|---|---|---|---|
| | Blend | Low Limits | High Limits |
| Raw Material | (w/w %) | (w/w %) | (w/w %) |
| Humic Acid¹ | 2 | 0.1 | 90 |
| Glucose² | 1 | 0.1 | 50 |
| Citric Acid³ | 0.5 | 0.01 | 10 |
| Iron Chelate⁴ | 0.15 | 0.01 | 10 |
| Surfactant⁵ | 2 | 0.1 | 90 |
| SymMAX ™ supramolecular | 94.35 | 1 | 99 |
| host water mixture⁶ | | | |

¹Commercially available as BorreGRO ® HA-1 powder from LignoTech AGRO
²Glucose - anhydrous lab grade from Aldon Corporation
³Citric Acid - anhydrous food grade from Harcros Chemicals, Inc.
⁴Iron monosodium EDTA from Greenway Biotech, Inc.
⁵Commercially available as Novel ® TDA-9 from Sasol Performance Chemicals
⁶Commercially available from Shotwell Hydrogenics, LLC or BPS Shotwell.

A control RTU formulation was also prepared using the ingredients and quantities shown in Table 2 below, but SymMAX™ supramolecular host water mixture was replaced with distilled water.

TABLE 2
CONTROL RTU FORMULATION
COMPONENTS AND AMOUNTS

| | Example | | |
|---|---|---|---|
| | Blend | Low Limits | High Limits |
| Raw Material | (w/w %) | (w/w %) | (w/w %) |
| Humic Acid¹ | 2 | 0.1 | 90 |
| Glucose² | 1 | 0.1 | 50 |
| Citric Acid³ | 0.5 | 0.01 | 10 |
| Iron Chelate⁴ | 0.15 | 0.01 | 10 |
| Surfactant⁵ | 2 | 0.1 | 90 |
| Distilled Water | 94.35 | 1 | 99 |

¹Commercially available as BorreGRO ® HA-1 powder from LignoTech AGRO
²Glucose - anhydrous lab grade from Aldon Corporation
³Citric Acid - anhydrous food grade from Harcros Chemicals, Inc.
⁴Iron monosodium EDTA from Greenway Biotech, Inc.
⁵Commercially available as Novel ® TDA-9 from Sasol Performance Chemicals

### Example 2: Supramolecular Structures

To understand the composition's response to fertilizer at a molecular level, a 20-20-20 fertilizer (20% nitrogen, 20% phosphorous, and 20% potassium) was mixed with water, and either the RTU formulation of Example 1 (hereinafter “Composition”) or the control RTU formulation of Example 1 (hereinafter “Control Composition”). The 20-20-20 fertilizer was prepared by dissolving 38% w/w fertilizer with 62% w/w water.

Three (3) solutions were prepared: (1) a 20-20-20 fertilizer/water solution; (2) a 20-20-20 fertilizer/water solution with 1% w/w of the Composition; and (3) a 20-20-20 fertilizer/water solution with 1% w/w of the Control Composition.

Microscopic slides were prepped by cleaning with soap and water, drying, then using an acetone solution and a Kimwipe to assure a clean slide was used with minimal contamination. Additionally, after cleaning the slide, a grade 1 filter paper was wrapped around the microscopic slide. Five (5) mL of solution was added by pipette to the top of the slide and allowed to dry over 12 hours.

All images were at 10× zoom level using an OMAX compound LED microscope with USB digital camera with zoom of about 50× for a combined zoom level of 500× magnification.

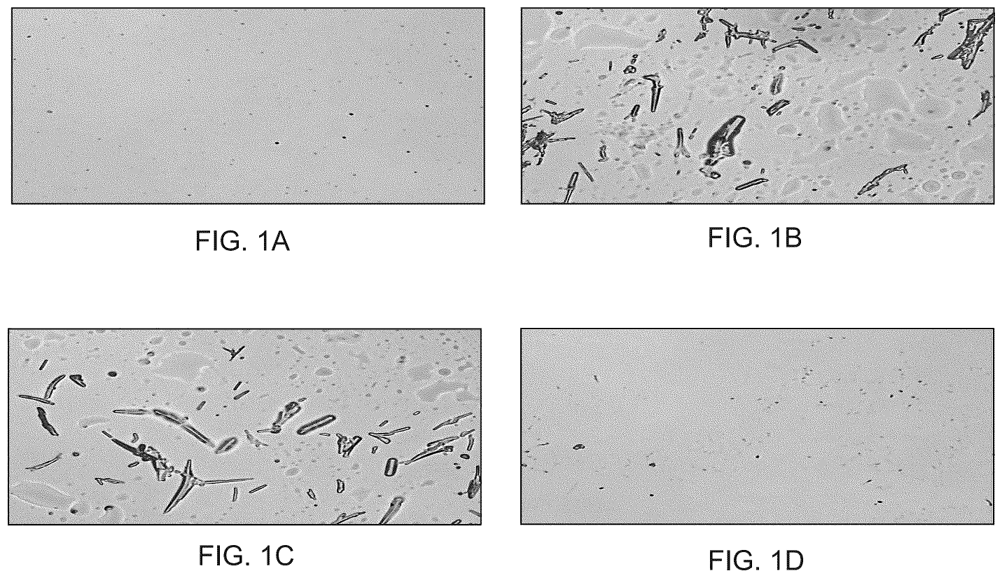

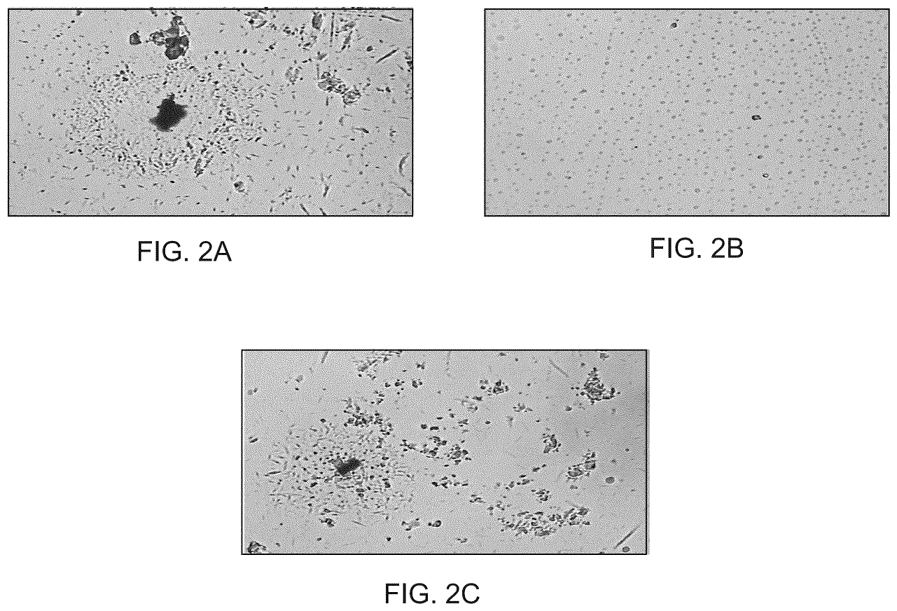

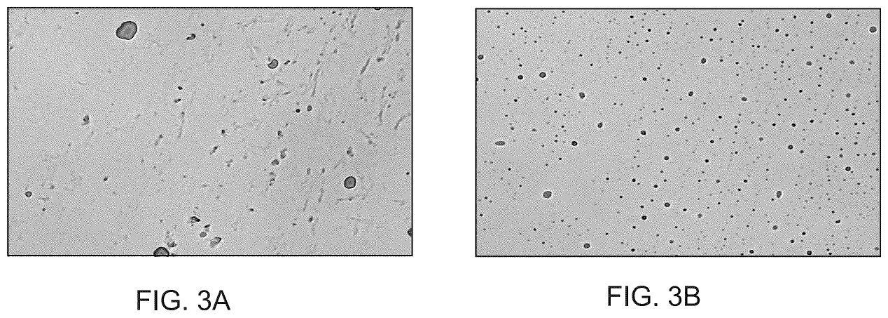

FIGS. 1A-1D show the crystal structures of the 20-20-20 fertilizer/water solution. FIGS. 2A-2C identify the uniform encapsulation of supramolecular structures in the solution of 20-20-20 fertilizer/water with the Composition. FIGS. 3A and 3B, the images of the solution of 20-20-20 fertilizer/water with the Control Composition, show randomized crystals.

### Example 3: Effect of Composition and Fertilizer on Ocimum basilicum (Sweet Basil) and Catharanthus Roseus (Periwinkle/Vincas)

Ocimum basilicum (sweet basil) and Catharanthus roseus (periwinkle/vincas) were purchased from a local nursery and grown at a temperature of 75° F., in a controlled light environment for 14 days. Sweet basil comprised of 3-4 plants per pot and were thinned to two homogenous plants per pot. Treatments included: 1) a control with fertilizer/water alone; 2) a fertilizer/water mix with the Composition; and 3) a fertilizer/water mix with the Control Composition. Plant heights, node counts, and wet and dry weights were recorded. Nutrient analysis was done by A&L laboratories in Fort Wayne, Indiana.

The fertilizer/water solutions were prepared by mixing 0.167% w/w 20-20-20 fertilizer with water (i.e., 1 gram of fertilizer with 599 grams of water). The Composition and the Control Composition were added to the fertilizer/water solutions at a 5% ratio relative to the added nitrogen in the fertilizer/water solution. In this example, 0.01 grams was added to the fertilizer/water solution as identified in Table 3.

TABLE 3
TREATMENT SOLUTIONS

| | 20-20-20 | Distilled | Composition |
|---|---|---|---|
| Treatment Solution | Fertilizer (g) | Water (g) | (g) |
| 1 | 1 | 599 | — |
| (Control) | | | |
| 2 | 1 | 599 | 0.01 |
| (Composition) | | | |
| 3 | 1 | 599 | 0.01 |
| (Control Composition) | | | |

Solutions were applied at trial initiation and 3 days later at 30 mL of solution at each application to 3-inch pots using the original pots from the nursery. Watering was added as needed 3 days after the final treatment application. Four replications of basil and three replications of vincas were used for proof of concept of the composition blend. Dry weight for basil roots could not be separated by plant and were recorded by pot. Nutrient assimilation was evaluated by A&L Laboratories, including homogenized composite samples for each treatment.

The results showed positive nutrient assimilation as well as an increase in biomass for the plants treated with the Composition compared to the control and the Control Composition.

TABLE 4
SWEET BASIL RESULTS WITH CONTROL

| | Dry Shoot | Dry Root |
|---|---|---|
| Replication | Biomass (g) | Weight (g) |
| 1a | 0.4 | 0.079 |
| 1b | 0.3 | 0.079 |
| 2a | 0.4 | 0.086 |
| 2b | 0.3 | 0.086 |
| 3a | 0.5 | 0.012 |
| 3b | 0.3 | 0.012 |
| 4a | 0.7 | 0.170 |
| 4b | 0.5 | 0.170 |
| Total Dry Biomass = 0.539 g | Average = 0.425 g | Average = 0.114 g |

TABLE 5
SWEET BASIL RESULTS WITH COMPOSITION

| | Dry Shoot | Dry Root |
|---|---|---|
| Replication | Biomass (g) | Weight (g) |
| 1a | 0.7 | 0.113 |
| 1b | 0.3 | 0.113 |
| 2a | 0.4 | 0.103 |
| 2b | 0.4 | 0.103 |
| 3a | 0.4 | 0.202 |
| 3b | 0.7 | 0.202 |
| 4a | 0.5 | 0.094 |
| 4b | 0.5 | 0.094 |
| Total Dry Biomass = 0.6155 g | Average = 0.488 g | Average = 0.128 g |

TABLE 6
SWEET BASIL RESULTS WITH CONTROL COMPOSITION

| | Dry Shoot | Dry Root |
|---|---|---|
| Replication | Biomass (g) | Weight (g) |
| la | 0.2 | 0.071 |
| 1b | 0.5 | 0.071 |
| 2a | 0.4 | 0.113 |
| 2b | 0.7 | 0.113 |
| 3a | 0.4 | 0.140 |
| 3b | 0.4 | 0.140 |
| 4a | 0.4 | 0.101 |
| 4b | 0.5 | 0.101 |
| Total Dry | Average = 0.438 g | Average = 0.106 g |
| Biomass = 0.54437 g | | |

TABLE 7
SWEET BASIL RESULTS OF ALL TREATMENTS

| Treatment Solution | Total Dry Biomass (g) |
|---|---|
| 1 - | 0.539 |
| (Control) | |
| 2 - | 0.616 |
| (Composition) | |
| 3 - | 0.544 |
| (Control Composition) | |

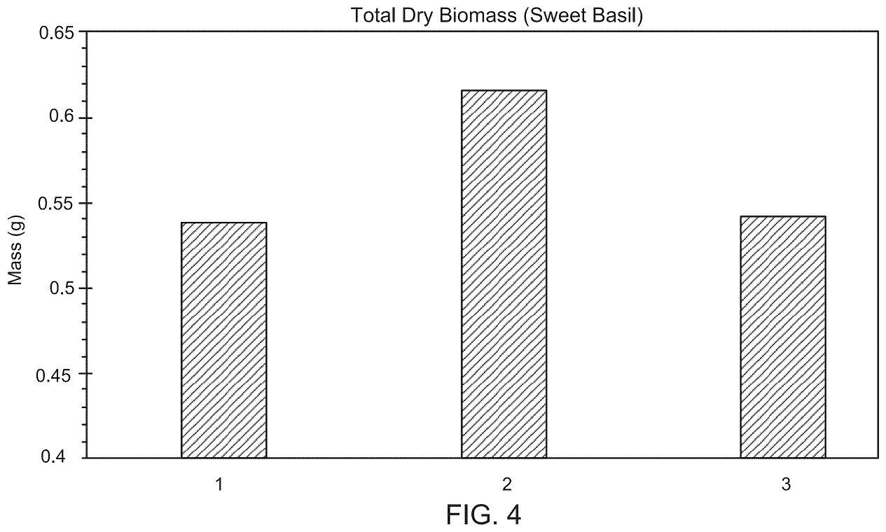

FIG. 4 illustrates the results of Table 7, showing that treatment with the Composition increases the biomass of sweet basil more than the control or the Control Composition.

TABLE 8
VINCAS RESULTS WITH CONTROL

| | Dry Shoot | Dry Root |
|---|---|---|
| Replication | Biomass (g) | Weight (g) |
| 1 | 0.7 | 0.145 |
| 2 | 0.9 | 0.073 |
| 3 | 1.0 | 0.093 |
| Total Dry Biomass = .97 g | Average = 0.87 g | Average = 0.104 g |

TABLE 9
VINCAS RESULTS WITH COMPOSITION

| | Dry Shoot | Dry Root |
|---|---|---|
| Replication | Biomass (g) | Weight (g) |
| 1 | 0.8 | 0.121 |
| 2 | 1.0 | 0.195 |
| 3 | 0.9 | 0.214 |
| Total Dry Biomass = 1.08 g | Average = 0.9 g | Average = 0.177 g |

TABLE 10
VINCAS RESULTS WITH CONTROL COMPOSITION

| | Dry Shoot | Dry Root |
|---|---|---|
| Replication | Biomass (g) | weight (g) |
| 1 | 0.8 | 0.1320 |
| 2 | 0.9 | 0.1333 |
| 3 | 0.6 | 0.1300 |
| Total Dry Biomass = 0.90 g | Average = 0.77 g | Average = 0.132 g |

TABLE 11
VINCAS RESULTS OF ALL TREATMENTS

| Treatment Solution | Total Dry Biomass (g) |
|---|---|
| 1 | 0.97 |
| (Control) | |
| 2 | 1.08 |
| (Composition) | |
| 3 | 0.90 |
| (Control Composition) | |

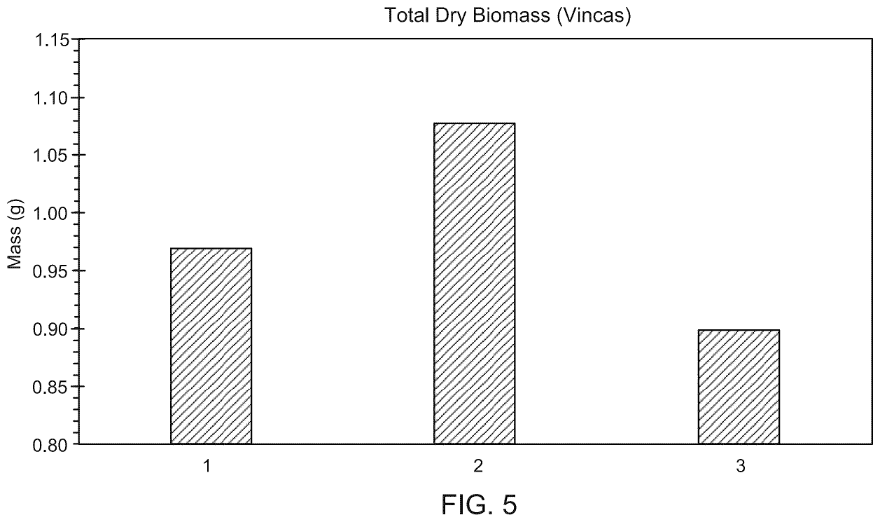

FIG. 5 illustrates the results of Table 11, showing that treatment with the Composition increases biomass of vincas more than the control or Control Composition.

TABLE 12
SWEET BASIL SHOOT NUTRIENT UPTAKE IN CONTROL

| Macronutrient | Measured (%) | Uptake (mg) |
|---|---|---|
| N | 5.659 | 192.4 |
| P | 1.086 | 36.9 |
| K | 5.142 | 174.8 |
| Ca | 1.983 | 67.4 |
| Mg | 0.549 | 18.7 |
| S | 0.423 | 14.4 |
| Shoot Biomass = 3.4 g | | |

TABLE 13
SWEET BASIL SHOOT NUTRIENT
UPTAKE IN COMPOSITION

| Macronutrient | Measured (%) | Uptake (mg) |
|---|---|---|
| N | 5.583 | 217.7 |
| P | 1.071 | 41.8 |
| K | 4.961 | 193.5 |
| Ca | 1.969 | 76.8 |
| Mg | 0.535 | 20.9 |
| S | 0.435 | 17.0 |
| Shoot Biomass = 3.9 g | | |

TABLE 14
SWEET BASIL SHOOT NUTRIENT UPTAKE
IN CONTROL COMPOSITION

| Macronutrient | Measured (%) | Uptake (mg) |
|---|---|---|
| N | 5.637 | 197.3 |
| P | 1.014 | 35.5 |
| K | 4.765 | 166.8 |
| Ca | 1.765 | 61.8 |
| Mg | 0.461 | 16.1 |
| S | 0.421 | 14.7 |
| Shoot Biomass = 3.5 g | | |

TABLE 15
SWEET BASIL ROOT NUTRIENT UPTAKE IN CONTROL

| Macronutrient | Measured (%) | Uptake (mg) |
|---|---|---|
| N | 3.019 | 13.8 |
| P | 0.478 | 2.2 |
| K | 2.14 | 9.8 |
| Ca | 1.651 | 7.5 |
| Mg | 0.355 | 1.6 |
| S | 0.296 | 1.3 |
| Root Biomass = 0.456 g | | |

TABLE 16
SWEET BASIL ROOT NUTRIENT
UPTAKE IN COMPOSITION

| Macronutrient | Measured (%) | Uptake (mg) |
|---|---|---|
| N | 2.456 | 12.6 |
| P | 0.317 | 1.6 |
| K | 1.376 | 7.0 |
| Ca | 1.317 | 6.7 |
| Mg | 0.251 | 1.3 |
| S | 0.227 | 1.2 |
| Root Biomass = 0.512 g | | |

TABLE 17
SWEET BASIL ROOT NUTRIENT UPTAKE
IN CONTROL COMPOSITION

| Macronutrient | Measured (%) | Uptake (mg) |
|---|---|---|
| N | 1.78 | 7.6 |
| P | 0.178 | 0.8 |
| K | 0.488 | 2.1 |
| Ca | 1.102 | 4.7 |
| Mg | 0.192 | 0.8 |
| S | 0.181 | 0.8 |
| Root Biomass = 0.425 g | | |

TABLE 18
SWEET BASIL SHOOT AND ROOT
NUTRIENT UPTAKE IN CONTROL

| Macronutrient | Measured (%) | Uptake (mg) |
|---|---|---|
| N | 8.678 | 334.6 |
| P | 1.564 | 53.2 |
| K | 7.282 | 247.6 |
| Ca | 3.634 | 123.6 |
| Mg | 0.904 | 30.7 |
| S | 0.719 | 24.4 |
| Combined | | Macronutrient Uptake |
| Biomass = 3.856 g | | Sum = 814.1 |

TABLE 19
SWEET BASIL SHOOT AND ROOT NUTRIENT
UPTAKE IN COMPOSITION

| Macronutrient | Measured (%) | Uptake (mg) |
|---|---|---|
| N | 8.039 | 354.7 |
| P | 1.388 | 61.2 |
| K | 6.337 | 279.6 |
| Ca | 3.286 | 145.0 |
| Mg | 0.786 | 34.7 |
| S | 0.662 | 29.2 |
| Combined | | Macronutrient Uptake |
| Biomass = 4.412 g | | Sum = 904.4 |
| | | Percent Difference with |
| | | Control = 11.1% |

TABLE 20
SWEET BASIL SHOOT AND ROOT NUTRIENT
UPTAKE IN CONTROL COMPOSITION

| Macronutrient | Measured (%) | Uptake (mg) |
|---|---|---|
| N | 7.417 | 291.1 |
| P | 1.192 | 46.8 |
| K | 5.253 | 206.2 |
| Ca | 2.867 | 112.5 |
| Mg | 0.653 | 25.6 |
| S | 0.602 | 23.6 |
| Combined | | Macronutrient Uptake |
| Biomass = 3.925 g | | Sum = 705.9 |
| | | Percent Difference with |
| | | Control = −13.3% |

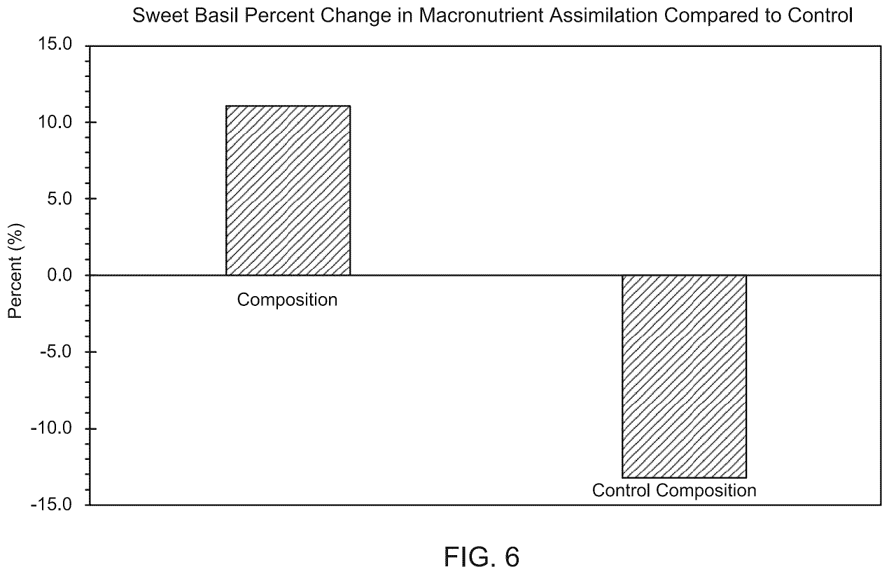

FIG. 6 illustrates the percent change in macronutrient assimilation for the Composition and the Control Composition compared to the control for sweet basil. As can be seen, the uptake for the Composition compared to the control was greater than positive 10%, while that for the Control Composition was greater than negative 10%, showing the additives in the composition.

TABLE 21
VINCAS SHOOT NUTRIENT UPTAKE IN CONTROL

| Macronutrient | Measured (%) | Uptake (mg) |
|---|---|---|
| N | 5.478 | 142.4 |
| P | 0.645 | 21.9 |
| K | 4.453 | 151.4 |
| Ca | 1.740 | 59.2 |
| Mg | 0.575 | 19.6 |
| S | 0.428 | 14.6 |
| Shoot Biomass = 2.6 g | | |

TABLE 22
VINCAS SHOOT NUTRIENT UPTAKE IN COMPOSITION

| Macronutrient | Measured (%) | Uptake (mg) |
|---|---|---|
| N | 5.493 | 148.3 |
| P | 0.589 | 15.9 |
| K | 4.507 | 121.7 |
| Ca | 1.644 | 44.4 |
| Mg | 0.535 | 14.4 |
| S | 0.400 | 10.8 |
| Shoot Biomass = 2.7 g | | |

TABLE 23
VINCAS SHOOT NUTRIENT UPTAKE
IN CONTROL COMPOSITION

| Macronutrient | Measured (%) | Uptake (mg) |
|---|---|---|
| N | 5.328 | 122.5 |
| P | 0.616 | 14.2 |
| K | 4.763 | 109.5 |
| Ca | 1.664 | 38.3 |
| Mg | 0.565 | 13.0 |
| S | 0.422 | 9.7 |
| Shoot Biomass = 2.3 g | | |

TABLE 24
VINCAS ROOT NUTRIENT UPTAKE IN CONTROL

| Macronutrient | Measured (%) | Uptake (mg) |
|---|---|---|
| N | 0 | 0 |
| P | 0.241 | 0.7 |
| K | 1.876 | 5.8 |
| Ca | 0.867 | 2.7 |
| Mg | 0.278 | 0.9 |
| S | 0.218 | 0.7 |
| Root Biomass = 0.311 g | | |

TABLE 25
VINCAS ROOT NUTRIENT UPTAKE IN COMPOSITION

| Macronutrient | Measured (%) | Uptake (mg) |
|---|---|---|
| N | 2.137 | 11.3 |
| P | 0.221 | 1.2 |
| K | 1.712 | 9.1 |
| Ca | 0.983 | 5.2 |
| Mg | 0.305 | 1.6 |
| S | 0.276 | 1.5 |
| Root Biomass = 0.53 g | | |

TABLE 26
VINCAS ROOT NUTRIENT UPTAKE
IN CONTROL COMPOSITION

| Macronutrient | Measured (%) | Uptake (mg) |
|---|---|---|
| N | 2.265 | 9.0 |
| P | 0.221 | 0.9 |
| K | 1.763 | 7.0 |
| Ca | 0.778 | 3.1 |
| Mg | 0.308 | 1.2 |
| S | 0.257 | 1.0 |
| Root Biomass = 0.3953 g | | |

TABLE 27
VINCAS SHOOT AND ROOT NUTRIENT
UPTAKE IN CONTROL

| Macronutrient | Measured (%) | Uptake (mg) |
|---|---|---|
| N | 5.478 | 159.5 |
| P | 0.886 | 30.1 |
| K | 6.329 | 215.2 |
| Ca | 2.607 | 88.6 |
| Mg | 0.853 | 29.0 |
| S | 0.646 | 22.0 |
| Combined | | Macronutrient Uptake |
| Biomass = 2.911 g | | Sum = 544.4 |

TABLE 28
VINCAS SHOOT AND ROOT NUTRIENT
UPTAKE IN COMPOSITION

| Macronutrient | Measured (%) | Uptake (mg) |
|---|---|---|
| N | 7.63 | 246.4 |
| P | 0.81 | 26.2 |
| K | 6.219 | 200.9 |
| Ca | 2.627 | 84.9 |
| Mg | 0.84 | 27.1 |
| S | 0.676 | 21.8 |
| Combined | | Macronutrient Uptake |
| Biomass = 3.23 g | | Sum = 607.3 |
| | | Percent Difference with |
| | | Control = 11.6% |

TABLE 29
VINCAS SHOOT AND ROOT NUTRIENT UPTAKE
IN CONTROL COMPOSITION

| Macronutrient | Measured (%) | Uptake (mg) |
|---|---|---|
| N | 7.593 | 204.7 |
| P | 0.837 | 22.6 |
| K | 6.526 | 175.9 |
| Ca | 2.442 | 65.8 |
| Mg | 0.873 | 23.5 |
| S | 0.679 | 18.3 |
| Combined | | Macronutrient Uptake |
| Biomass = 2.6953 g | | Sum = 510.8 |
| | | Percent Difference with |
| | | Control = −6.2% |

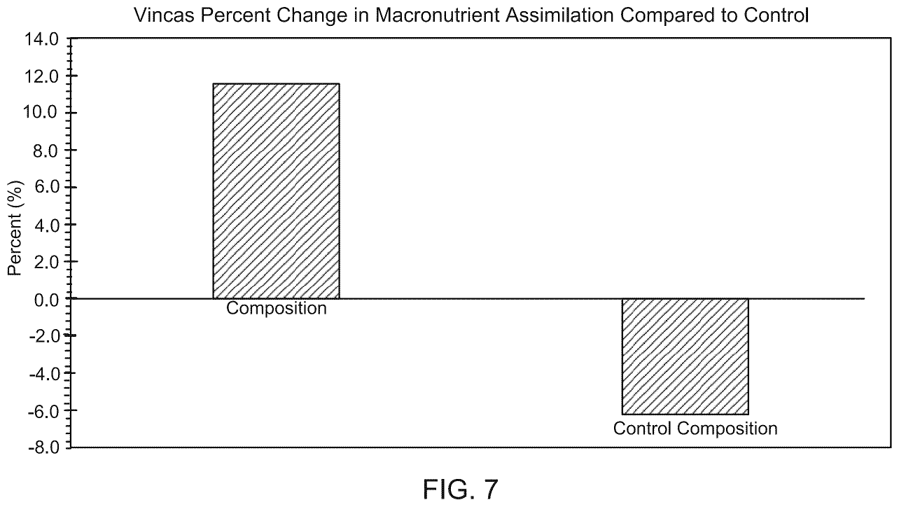

FIG. 7 illustrates the percent change in macronutrient assimilation for the Composition and the Control Composition compared to the control for vincas. As can be seen, the uptake for the Composition compared to the control was greater than positive 10%, while that for the Control Composition was greater than negative 6%. The uptake noted in Tables 12-29, for example, is measured in mg/treatment.

### Example 4: Effect of Composition and Fertilizer on Zea mays (Corn)

This example was designed to identify intended application rates of the Composition based on the amount of nitrogen to be applied. This was done by varying the rates of 20-10-20 Peters Professional® General purpose fertilizer at 0, 50, 100, and 200 ppm of nitrogen at application with five rates of the Composition at 0, 20, 50, 100, and 200 ppm based on grams of soilless media used in the cones for the trial. The soilless media composition was 75/25 (w/w %) of Kolorscape All Purpose Sand and Premier Tech Horticulture Pro-Mix LP15, respectively. Zero ppm of fertilizer is utilized as the baseline to understand how much macronutrients were available in the soilless media to understand nutrient competition and assimilation.

TABLE 30
NUTRIENT CONCENTRATIONS IN 20-10-20 FERTILIZER

| 20-10-20 Peters Professional ® | |
|---|---|
| General Purpose Fertilizer | % |
| N (Nitrogen) | 20% |
| P₂O₅ (Available | 10% |
| Phosphorus) | |
| K₂O (Potash) | 20% |
| Mg (Magnesium) | 0.150% |
| B (Boron) | 0.013% |
| Cu (Copper) | 0.013% |
| Fe (Iron) | 0.050% |
| Mn (Manganese) | 0.025% |
| Mo (Molybdenum) | 0.005% |
| Zn (Zinc) | 0.025% |
| S (Sulfur) | 0.197% |

TABLE 31
MILLIGRAMS OF NUTRIENTS ADDED
BASED ON PPM OF NITROGEN

| 20-10-20 Peters Professional ® | | | |
|---|---|---|---|
| General Purpose Fertilizer | 50 ppm N | 100 ppm N | 200 ppm N |
| N (Nitrogen) | 7.0 | 14.0 | 28.0 |
| P₂O₅ (Available | 3.5 | 7.0 | 14.0 |
| Phosphorus) | | | |
| K₂O (Potash) | 7.0 | 14.0 | 28.0 |
| Mg (Magnesium) | 0.053 | 0.105 | 0.210 |
| B (Boron) | 0.004 | 0.009 | 0.018 |
| Cu (Copper) | 0.004 | 0.009 | 0.018 |
| Fe (Iron) | 0.018 | 0.035 | 0.070 |
| Mn (Manganese) | 0.009 | 0.018 | 0.035 |
| Mo (Molybdenum) | 0.002 | 0.004 | 0.007 |
| Zn (Zinc) | 0.009 | 0.018 | 0.035 |
| S (Sulfur) | 0.069 | 0.138 | 0.276 |

The 20-10-20 fertilizer was dissolved with water at 16.65% w/w fertilizer and 83.35% w/w water to promote homogeneity in the fertilizer. The study was carried out for 16 days with treatments being applied at emergence on day 4 and on day 12.

Data was analyzed for nutrient assimilation and dry biomass for roots and shoots. Nine (9) replications for each treatment were evaluated for dry biomass. Samples were grouped by 3 for nutrient analysis completed by A&L laboratories in Fort Wayne, Indiana.

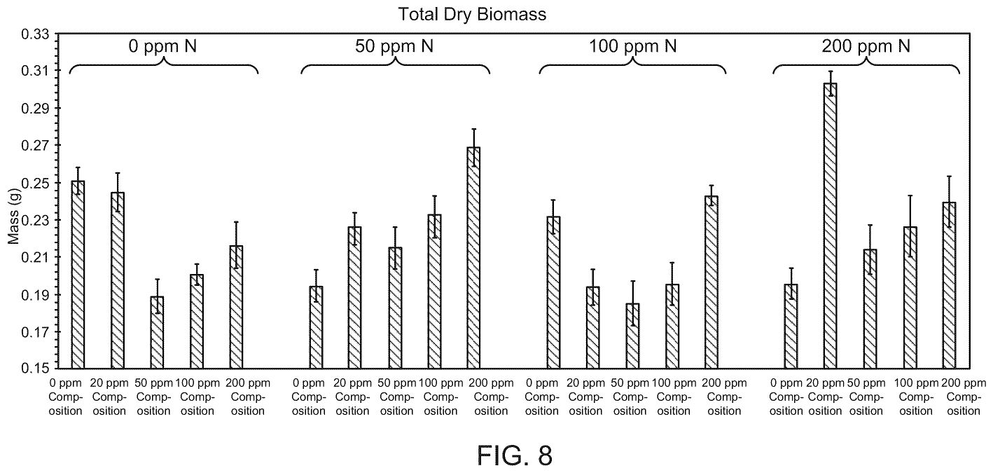

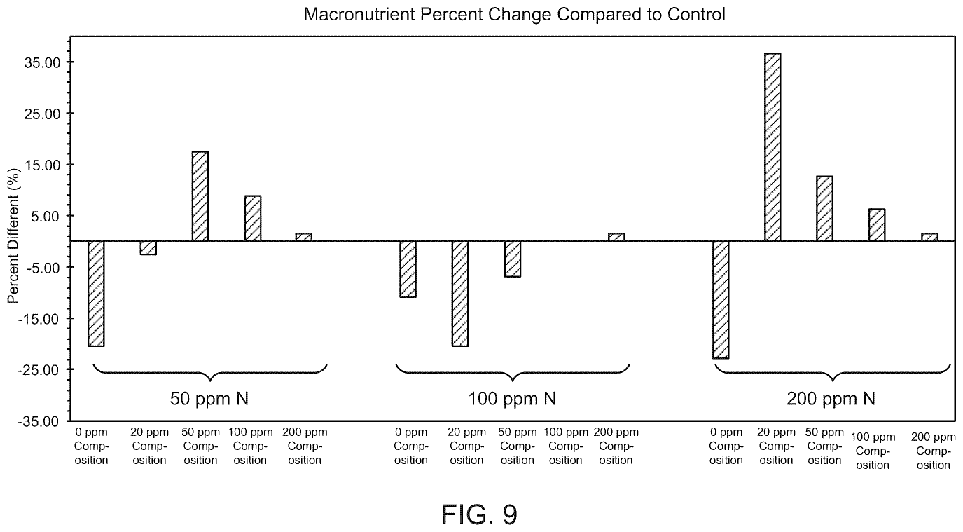

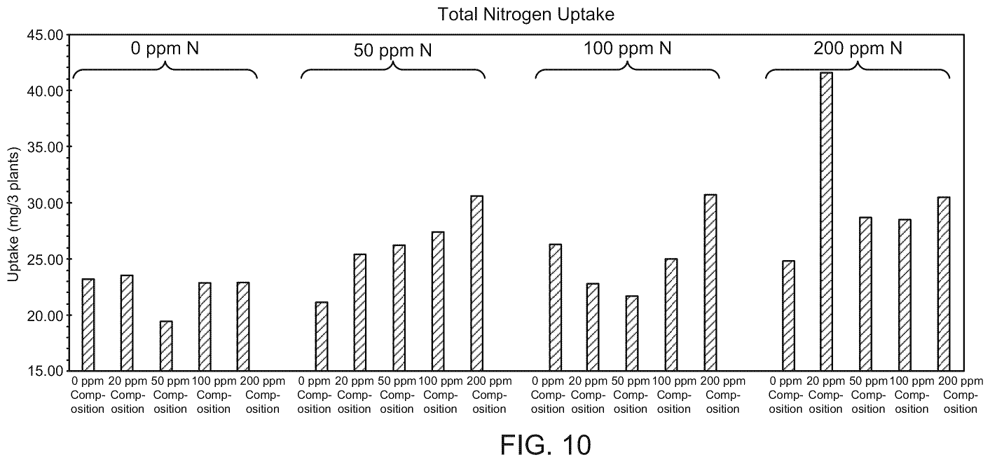

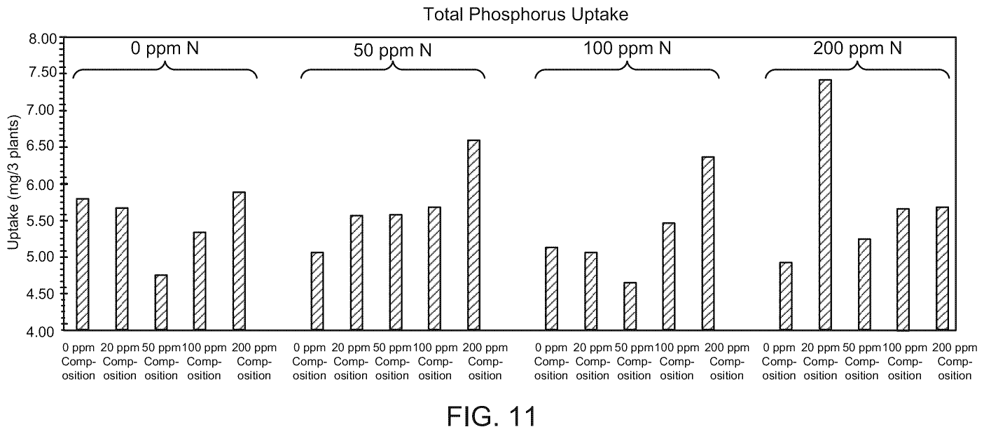

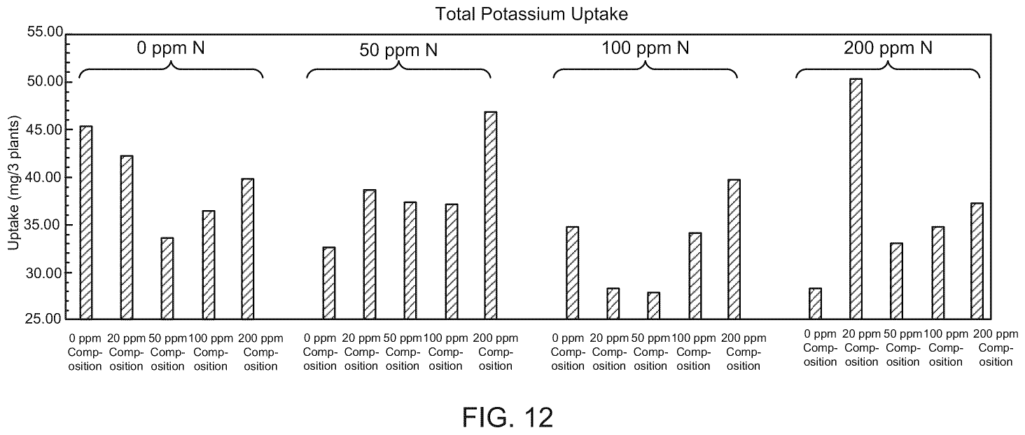

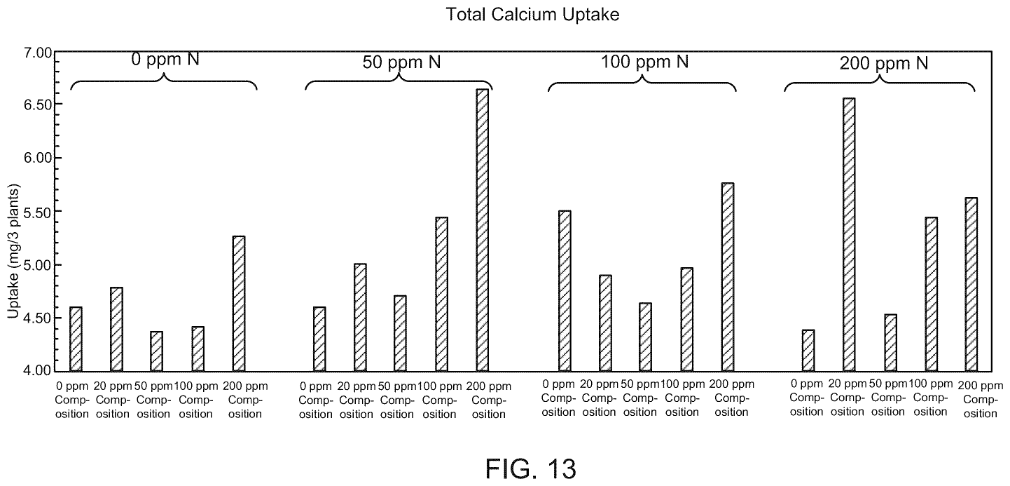

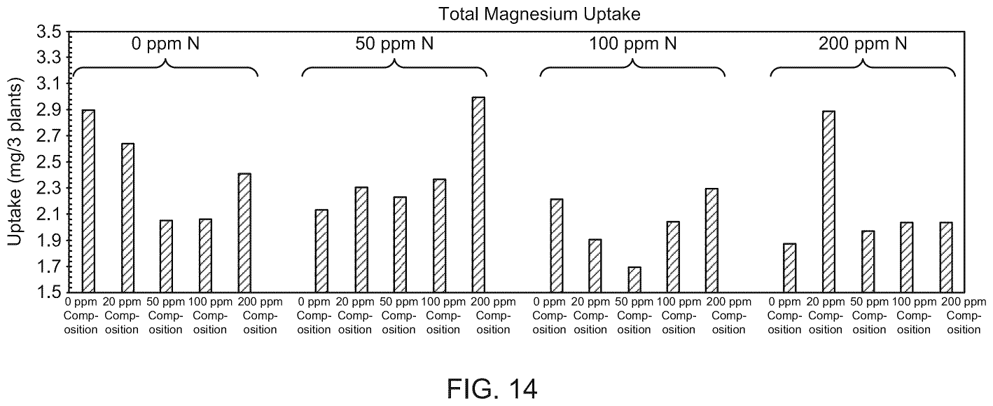

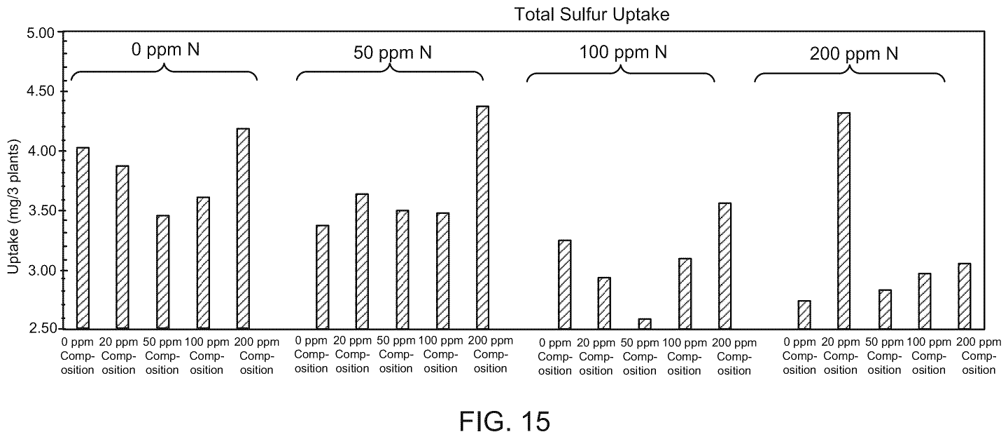

Data shown is total dry biomass (FIG. 8), percent change in macronutrient assimilation compared to control (FIG. 9), total nitrogen uptake (FIG. 10), total phosphorus uptake (FIG. 11), total potassium uptake (FIG. 12), total calcium uptake (FIG. 13), total magnesium uptake (FIG. 14), and total sulfur uptake (FIG. 15). All values in parentheses represent the percent difference comparing the assimilation of nutrients after the baseline control is subtracted.

TABLE 32
DRY SHOOT AND ROOT BIOMASS AT 0 PPM NITROGEN

| Compo- | 0 | 20 | 50 | 100 | 200 |
|---|---|---|---|---|---|
| sition | ppm | ppm | ppm | ppm | ppm |
| Dry | 0.1561 | 0.1535 | 0.1170 | 0.1219 | 0.1394 |
| Shoot | | | | | |
| Dry | 0.0948 | 0.0913 | 0.0719 | 0.0789 | 0.0769 |
| Root | | | | | |
| Total | 0.2510 | 0.2449 | 0.1889 | 0.2008 | 0.2163 |
| Dry | | | | | |

TABLE 33
DRY SHOOT AND ROOT BIOMASS AT 50 PPM NITROGEN

| Compo- | 0 | 20 | 50 | 100 | 200 |
|---|---|---|---|---|---|
| sition | ppm | ppm | ppm | ppm | ppm |
| Dry | 0.1168 | 0.1436 | 0.1305 | 0.1455 | 0.1737 |
| Shoot | | | | | |
| Dry | 0.0778 | 0.0819 | 0.0842 | 0.0861 | 0.0950 |
| Root | | | | | |
| Total | 0.1946 | 0.2255 | 0.2148 | 0.2317 | 0.2688 |
| Dry | | | | | |
| | | (54.81%) | (35.39%) | (65.71%) | (131.47%) |

TABLE 34
DRY SHOOT AND ROOT BIOMASS AT 100 PPM NITROGEN

| Compo- | 0 | 20 | 50 | 100 | 200 |
|---|---|---|---|---|---|
| sition | ppm | ppm | ppm | ppm | ppm |
| Dry | 0.1414 | 0.1161 | 0.1153 | 0.1224 | 0.1551 |
| Shoot | | | | | |
| Dry | 0.0903 | 0.0778 | 0.0699 | 0.0733 | 0.0880 |
| Root | | | | | |
| Total | 0.2317 | 0.1939 | 0.1852 | 0.1957 | 0.2431 |
| Dry | | | | | |
| | | (−195.23%) | (−240.46%) | (−185.92%) | (59.02%) |

TABLE 35
DRY SHOOT AND ROOT BIOMASS AT 200 PPM NITROGEN

| Compo- | 0 | 20 | 50 | 100 | 200 |
|---|---|---|---|---|---|
| sition | ppm | ppm | ppm | ppm | ppm |
| Dry | 0.1152 | 0.2142 | 0.1361 | 0.1535 | 0.1599 |
| Shoot | | | | | |
| Dry | 0.0807 | 0.0888 | 0.0778 | 0.0731 | 0.0798 |
| Root | | | | | |
| Total | 0.1960 | 0.3030 | 0.2139 | 0.2266 | 0.2397 |
| Dry | | | | | |
| | | (194.41%) | (32.55%) | (55.56%) | (79.47%) |

FIG. 8 is a graph of the results of Tables 32-35. In most instances, the addition of the Composition with fertilizer resulted in an increase in biomass when compared to the fertilizer without the Composition.

TABLE 36
NUTRIENT UPTAKE AT 0 PPM NITROGEN

| Composition | | N | P | K | Ca | Mg | S |
|---|---|---|---|---|---|---|---|
| 0 | ppm | 23.18 | 5.78 | 45.43 | 5.47 | 2.90 | 4.04 |
| 20 | ppm | 23.57 | 5.67 | 42.39 | 4.78 | 2.64 | 3.89 |
| 50 | ppm | 19.51 | 4.76 | 33.70 | 4.38 | 2.05 | 3.46 |
| 100 | ppm | 22.89 | 5.35 | 36.55 | 4.43 | 2.07 | 3.62 |
| 200 | ppm | 22.96 | 5.89 | 39.91 | 5.27 | 2.42 | 4.20 |

TABLE 37
NUTRIENT UPTAKE AT 50 PPM NITROGEN

| Composition | | N | P | K | Ca | Mg | S |
|---|---|---|---|---|---|---|---|
| 0 | ppm | 21.12 | 5.07 | 32.65 | 4.61 | 2.14 | 3.38 |
| 20 | ppm | 25.48 | 5.55 | 38.63 | 5.01 | 2.30 | 3.65 |
| | | (+193%) | (+84%) | (+71%) | (+126%) | (+55%) | (+64%) |
| 50 | ppm | 26.28 | 5.58 | 37.40 | 4.72 | 2.24 | 3.51 |
| | | (+429%) | (+215%) | (+129%) | (+139%) | (+125%) | (+107%) |
| 100 | ppm | 27.44 | 5.68 | 37.21 | 5.45 | 2.37 | 3.49 |
| | | (+322%) | (+147%) | (+105%) | (+219%) | (+140%) | (+81%) |
| 200 | ppm | 30.67 | 6.59 | 46.76 | 6.64 | 3.00 | 4.38 |
| | | (+475%) | (+198%) | (+154%) | (+260%) | (+177%) | (+127%) |

TABLE 38
NUTRIENT UPTAKE AT 100 PPM NITROGEN

| Composition | | N | P | K | Ca | Mg | S |
|---|---|---|---|---|---|---|---|
| 0 | ppm | 26.23 | 5.12 | 34.95 | 5.51 | 2.22 | 3.26 |
| 20 | ppm | 22.86 | 5.05 | 28.35 | 4.89 | 1.91 | 2.94 |
| | | (−124%) | (+6.00%) | (−34%) | (+163%) | (−8%) | (−21%) |
| 50 | ppm | 21.63 | 4.66 | 27.85 | 4.65 | 1.70 | 2.60 |
| | | (−30%) | (+85%) | (+44%) | (+525%) | (+49%) | (−10%) |
| 100 | ppm | 25.03 | 5.46 | 34.24 | 4.96 | 2.05 | 3.10 |
| | | (−30%) | (+118%) | (+78%) | (+1140%) | (+98%) | (+34%) |
| 200 | ppm | 30.72 | 6.35 | 39.78 | 5.75 | 2.30 | 3.57 |
| | | (+154%) | (+170%) | (+99%) | (+1020%) | (+82%) | (+19%) |

TABLE 39
NUTRIENT UPTAKE AT 200 PPM NITROGEN

| Composition | | N | P | K | Ca | Mg | S |
|---|---|---|---|---|---|---|---|
| 0 | ppm | 24.76 | 4.93 | 28.32 | 4.39 | 1.88 | 2.76 |
| 20 | ppm | 41.56 | 7.42 | 50.48 | 6.56 | 2.89 | 4.33 |
| | | (+1035%) | (+305%) | (+147%) | (+266%) | (+124%) | (+134%) |
| 50 | ppm | 28.70 | 5.25 | 33.09 | 4.53 | 1.97 | 2.83 |
| | | (+480%) | (+158%) | (+96%) | (+114%) | (+93%) | (+51%) |
| 100 | ppm | 28.53 | 5.64 | 34.92 | 5.45 | 2.03 | 2.98 |
| | | (+256%) | (+135%) | (+91%) | (+195%) | (+97%) | (+50) |
| 200 | ppm | 30.51 | 5.68 | 37.28 | 5.62 | 2.04 | 3.06 |
| | | (+376%) | (+75%) | (+85%) | (+133%) | (+63%) | (+11%) |

TABLE 40
MACRONUTRIENT UPTAKE DIFFERENCE COMPARED
TO CONTROL AT 0 PPM NITROGEN

| | | 0 ppm | 50 ppm | 100 ppm | 200 ppm |
|---|---|---|---|---|---|
| Composition | | nitrogen | nitrogen | nitrogen | nitrogen |
| 0 | ppm | 86.79 | 68.96 | 77.28 | 67.03 |
| | | | (−−20.5%) | (−11.0%) | (−22.8%) |
| 20 | ppm | 82.94 | 80.63(−2.8%) | 66.00(−20.4%) | 113.23(36.5%) |
| 50 | ppm | 67.87 | 79.71(17.5%) | 63.11(−7.0%) | 76.39(12.5%) |
| 100 | ppm | 74.90 | 81.65(9.0%) | 74.84(−0.07%) | 79.56(6.2%) |
| 200 | ppm | 80.64 | 98.04(21.5%) | 88.45(9.7%) | 84.18(4.4%) |

FIG. 9 illustrates the results of Table 40. The addition of fertilizer showed less uptake by the plants without the Composition. With the Composition, there was an improvement in nutrient uptake, making the fertilizer more available to the plant. The nutrient uptake for Tables 36-40 is mg/plant set, where a set is used in these Tables to mean 3 plants. When a plant absorbs nutrients, there is often competition as to which nutrients are absorbed. This can cause a negative % difference for one or more micro- or macro-nutrients when multiple nutrients are applied concurrently and/or present in the soil in meaningful amounts. This effect can be minimized by applying fewer types of nutrients at one time. Moreover, for each fertilizer N ppm concentration set, even with multiple macronutrients data is provided herein that showed positive percentage differences and demonstrated that reduced amounts of macronutrients can be present in the fertilizer being applied but having the effective of a much larger percentage of that macronutrient since more will be assimilated into the plant due to the stability and uptake boost of the presently disclosed compositions. When a data point for a macronutrient in a given amount has a percent difference of 100% (or greater) when mixed with the inventive composition, this means one can use 1 lb. of fertilizer with that nutrient and it will have the same effect on the plant as if 2 lbs. had been used, thereby reducing the cost by half and minimizing any environmental effects of greater fertilizer usage at the same time. These percentages are calculated as follows:

$$( \frac{\begin{matrix}( ( Inventive Blend at N PPM - \\ 0 ppm Control for Inventive Blend ) \cdot \\ ( N ppm - 0 ppm Control ) )\end{matrix}}{( Absolute ( N ppm - 0 ppm Control ) )} ) \times 100 = \% Diff$$

TABLE 41
TOTAL NITROGEN UPTAKE

| | | | | |
|---|---|---|---|---|
| | 0 ppm | 50 ppm | 100 ppm | 200 ppm |
| Composition | nitrogen | nitrogen | nitrogen | nitrogen |

| | | | | | |
|---|---|---|---|---|---|
| 0 | ppm | 23.18 | 21.12 | 26.23 | 24.76 |
| 20 | ppm | 23.57 | 25.48 | 22.86 | 41.56 |
| | | | (+193%) | (−124%) | (+1035%) |
| 50 | ppm | 19.51 | 26.28 | 21.63 | 28.70 |
| | | | (+429%) | (−193%) | (+480%) |
| 100 | ppm | 22.89 | 27.44 | 25.03 | 28.53 |
| | | | (+322%) | (−30%) | (+256%) |
| 200 | ppm | 22.96 | 30.67 | 30.72 | 30.51 |
| | | | (+475%) | (+154%) | (+376%) |

FIG. 10 illustrates the results of Table 41. The addition of fertilizer showed less uptake by the plants without the Composition. With the Composition, there was an improvement in nutrient uptake, making the fertilizer more available to the plant.

TABLE 42
TOTAL PHOSPHORUS UPTAKE

| | | | | |
|---|---|---|---|---|
| | 0 ppm | 50 ppm | 100 ppm | 200 ppm |
| Composition | nitrogen | nitrogen | nitrogen | nitrogen |

| | | | | | |
|---|---|---|---|---|---|
| 0 | ppm | 5.78 | 5.07 | 5.12 | 4.93 |
| 20 | ppm | 5.67 | 5.55 | 5.05 | 7.42 |
| | | | (+84%) | (+6%) | (+305%) |
| 50 | ppm | 4.76 | 5.58 | 4.66 | 5.25 |
| | | | (+215%) | (+85%) | (+158%) |
| 100 | ppm | 5.35 | 5.68 | 5.46 | 5.64 |
| | | | (+147%) | (+118%) | (+135%) |
| 200 | ppm | 5.89 | 6.59 | 6.35 | 5.68 |
| | | | (+198%) | (+170%) | (+75%) |

FIG. 11 illustrates the results of Table 42. The addition of fertilizer showed less uptake by the plants without the Composition. With the Composition, there was an improvement in nutrient uptake, making the fertilizer more available to the plant.

TABLE 43
TOTAL POTASSIUM UPTAKE

| | | | | |
|---|---|---|---|---|
| | 0 ppm | 50 ppm | 100 ppm | 200 ppm |
| Composition | nitrogen | nitrogen | nitrogen | nitrogen |

| | | | | | |
|---|---|---|---|---|---|
| 0 | ppm | 45.43 | 32.65 | 34.95 | 28.32 |
| 20 | ppm | 42.39 | 38.63 | 28.35 | 50.48 |
| | | | (+71%) | (−34%) | (+147%) |
| 50 | ppm | 33.70 | 37.40 | 27.85 | 33.09 |
| | | | (+129%) | (+44%) | (+96%) |
| 100 | ppm | 36.55 | 37.21 | 34.24 | 34.92 |
| | | | (+105%) | (+78%) | (+91%) |
| 200 | ppm | 39.91 | 46.76 | 39.78 | 37.28 |
| | | | (+154%) | (+99%) | (+85%) |

FIG. 12 illustrates the results of Table 43. The addition of fertilizer showed less uptake by the plants without the Composition. With the Composition, there was an improvement in nutrient uptake, making the fertilizer more available to the plant.

TABLE 44
TOTAL CALCIUM UPTAKE

| | | | | |
|---|---|---|---|---|
| | 0 ppm | 50 ppm | 100 ppm | 200 ppm |
| Composition | nitrogen | nitrogen | nitrogen | nitrogen |

| | | | | | |
|---|---|---|---|---|---|
| 0 | ppm | 5.47 | 4.61 | 5.51 | 4.39 |
| 20 | ppm | 4.78 | 5.01 | 4.89 | 6.56 |
| | | | (+126%) | (+163%) | (+266%) |
| 50 | ppm | 4.38 | 4.72 | 4.65 | 4.53 |
| | | | (+139%) | (+525%) | (+114%) |
| 100 | ppm | 4.43 | 5.45 | 4.96 | 5.45 |
| | | | (+219%) | (+1140%) | (+195%) |
| 200 | ppm | 5.27 | 6.64 | 5.75 | 5.62 |
| | | | (+260%) | (+1020%) | (+133%) |

FIG. 13 illustrates the results of Table 44. The addition of fertilizer showed less uptake by the plants without the Composition. With the Composition, there was an improvement in nutrient uptake, making the fertilizer more available to the plant.

TABLE 45
TOTAL MAGNESIUM UPTAKE

| | | | | |
|---|---|---|---|---|
| | 0 ppm | 50 ppm | 100 ppm | 200 ppm |
| Composition | nitrogen | nitrogen | nitrogen | nitrogen |

| | | | | | |
|---|---|---|---|---|---|
| 0 | ppm | 2.90 | 2.14 | 2.22 | 1.88 |
| 20 | ppm | 2.64 | 2.30 | 1.91 | 2.89 |
| | | | (+55%) | (−8%) | (+124%) |
| 50 | ppm | 2.05 | 2.24 | 1.70 | 1.97 |
| | | | (+125%) | (+49%) | (+93%) |
| 100 | ppm | 2.07 | 2.37 | 2.05 | 2.03 |
| | | | (+140%) | (+98%) | (+97%) |
| 200 | ppm | 2.42 | 3.00 | 2.30 | 2.04 |
| | | | (+177%) | (+82%) | (+63%) |

FIG. 14 illustrates the results of Table 45. The addition of fertilizer showed less uptake by the plants without the Composition. With the Composition, there was an improvement in nutrient uptake, making the fertilizer more available to the plant.

TABLE 46
TOTAL SULFUR UPTAKE

| | | | | |
|---|---|---|---|---|
| | 0 ppm | 50 ppm | 100 ppm | 200 ppm |
| Composition | nitrogen | nitrogen | nitrogen | nitrogen |

| | | | | | |
|---|---|---|---|---|---|
| 0 | ppm | 4.04 | 3.38 | 3.26 | 2.76 |
| 20 | ppm | 3.89 | 3.65 | 2.94 | 4.33 |
| | | | (+64%) | (−21%) | (+134%) |
| 50 | ppm | 3.46 | 3.51 | 2.60 | 2.83 |
| | | | (+107%) | (−10%) | (+51%) |
| 100 | ppm | 3.62 | 3.49 | 3.10 | 2.98 |
| | | | (+81%) | (+34%) | (+50%) |
| 200 | ppm | 4.20 | 4.38 | 3.57 | 3.06 |
| | | | (+127%) | (+19%) | (+11%) |

FIG. 15 illustrates the results of Table 46. The addition of fertilizer showed less uptake by the plants without the Composition. With the Composition, there was an improvement in nutrient uptake, making the fertilizer more available to the plant. On average the macronutrient assimilation was increased by 200%. This means a grower could potentially use 50% less fertilizer per acre and achieve the same results or better when using supramolecular host chemistries.

Although only a few exemplary embodiments have been described in detail above, those of ordinary skill in the art will readily appreciate that many other modifications are possible in the exemplary embodiments without materially departing from the novel teachings and advantages of the present invention. Accordingly, all such modifications are intended to be included within the scope of the present invention as defined in the following claims.

1-25. (canceled)

26. An agricultural composition comprising:
a macronutrient source;
a supramolecular host chemical or a supramolecular guest chemical configured to engage in host-guest chemistry with the macronutrient source; and
a solvent.

27. The composition of claim 26, wherein the macronutrient source comprises nitrogen, phosphorus, potassium, calcium, sulfur, or magnesium, or a salt thereof, or a combination thereof.

28. The composition of claim 26, further comprising agricultural additives which comprise one or more of:
a biostimulant;
a sugar;
an acid;
an iron source; and
a surfactant.

29. The composition of claim 26, wherein the macronutrient source is present in an amount of about 0.01 to 35 percent by weight of the composition and the supramolecular host chemical or supramolecular guest chemical is present in an amount of about 1 percent to about 90 percent of the composition.

30. The composition of claim 26, wherein the supramolecular host chemical is present and comprises a nanostructure having a charge, magnetic properties, or both.

31. The composition of claim 26, wherein the solvent comprises water.

32. The composition of claim 26, wherein the solvent is present in an amount of 0.5 percent to about 80 percent by weight of the composition.

33. A method of preparing the composition of claim 26, which comprises:
forming a mixture of the solvent and the supramolecular host chemical or the supramolecular guest chemical; and
adding the macronutrient source to form the composition.

34. A method of treating a plant to improve nutrient assimilation or vigor, comprising:
applying an agricultural composition to the plant in an agriculturally effective amount, the composition comprising:
a macronutrient source;
a supramolecular host chemical or a supramolecular guest chemical configured to engage in host-guest chemistry with the macronutrient source; and
a solvent.

35. The method of claim 34, wherein:
the composition is applied at a concentration of about 1.0 to about 1.5 mL of the composition per gallon of carrier fluid, or about 9.0 mL to about 20.0 mL of the composition per gallon of carrier fluid, or
the composition is applied at a rate of about 1 ounce to about 3 ounces of the composition per acre of the plant or about 70 ounces to about 90 ounces of the composition per acre of the plant.

36. The method of claim 34, wherein the composition is applied by injection, drip, broadcast, banding, soil drench, foliarly, by fertigation, aerially, or a combination thereof.

37. The method of claim 34, wherein the macronutrient source is selected to comprise nitrogen, phosphorus, potassium, calcium, sulfur, or magnesium, or a salt thereof, or a combination thereof.

38. The method of claim 34, wherein the macronutrient source is selected to comprise an amount of about 0.01 percent to 5 percent by weight of the composition or the supramolecular host chemical or supramolecular guest chemical is selected to comprise an amount of about 1 percent to about 90 percent by weight of the composition.

39. The method of claim 34, wherein the supramolecular host chemical is present and comprises a nanostructure having a charge, magnetic properties, or both.

40. The method of claim 37, which further comprises increasing a plant weight or a nutrient uptake in the plant compared to a plant that did not receive the agriculturally effective amount of the composition.

41. The method of claim 40, wherein there is an increased nutrient uptake of nitrogen, phosphorous, potassium, calcium, magnesium, sulfur, or a combination thereof in the plant.

42. A method of increasing the assimilation of one or more macronutrients in a plant, which comprises applying an agriculturally effective amount of the agricultural composition of claim 26 to the plant.

43. The method of claim 42, wherein the agricultural composition further includes an additive that comprises one or more adjuvants, water conditioning agents, buffering agents, defoamers, drift control agents, stickers, spreaders, tank cleaners, fertilizers, and biostimulants.

44. An agricultural formulation comprising:
a macronutrient source including a fertilizer which comprises nitrogen, phosphorus, potassium, calcium, magnesium, optionally sulfur, or a salt thereof, or a combination thereof;
a plurality of agricultural additives which comprises:
a biostimulant,
a sugar,
an acid,
an iron source, and
a surfactant;
a supramolecular host chemical or a supramolecular guest chemical configured to engage in host-guest chemistry with at least one of the agricultural additives; and
a solvent.

45. The agricultural formulation of claim 44, wherein the sugar comprises glucose or fructose; the biostimulant comprises humic acid; the acid comprises citric acid; the iron source comprises an iron chelate; and the surfactant comprises an ethoxylate.

46. A method of increasing the assimilation of one or more macronutrients in a plant,
which comprises:
combining an agriculturally effective amount of the agricultural formulation of claim 44 and a macronutrient source to form an agricultural composition; and
applying the agricultural combination to the plant to increase assimilation to the plant of at least one macronutrient in the macronutrient source.
